(19) United States
(12) Patent Application Publication
(10) Pub. No.: US 2023/0198003 A1
(43) Pub. Date: Jun. 22, 2023

(54) COMPOSITE SOLID STATE ELECTROLYTE SLURRY, FILM, PREPARATION METHOD AND ALL SOLID STATE BATTERY

(71) Applicant: Southern University of Science and Technology, Shenzhen, Guangdong (CN)

(72) Inventors: Juncao BIAN, Shenzhen, Guangdong (CN); Zhouguang LU, Shenzhen, Guangdong (CN); Yusheng ZHAO, Shenzhen, Guangdong (CN)

(73) Assignee: Southern University of Science and Technology, Shenzhen, Guangdong (CN)

(21) Appl. No.: 17/606,132

(22) PCT Filed: Jun. 15, 2021
(86) PCT No.: PCT/CN2021/100173

§ 371 Date: Oct. 25, 2021

(30) Foreign Application Priority Data
Dec. 21, 2020 (CN) 202011520126.3

(51) Int. Cl. H01M 10/056; H01M 10/0525

(52) U.S. Cl. CPC H01M 10/056; H01M 10/0525; H01M 2300/0085

(57) ABSTRACT

The present application provides a composite solid state electrolyte slurry, a film, a preparation method, and an all solid state battery. The method includes: adding a polymer into a non-polar solvent and mixing the polymer and the non-polar solvent to obtain a sol; adding a solid state electrolyte powder and a lithium salt solution into the sol and mixing the solid state electrolyte powder, the lithium salt solution and the sol to obtain a composite solid state electrolyte slurry; the non-polar solvent is an organic solvent that does not react with the solid state electrolyte powder; the high shear force of the sol is used to disperse the solid state electrolyte powder and lithium salt solution, thereby the solid state electrolyte powder and the lithium salt solution are uniformly dispersed in the sol.

### CROSS-REFERENCE TO RELATED APPLICATIONS

This application is the U.S. national phase of PCT Application No. PCT/CN2021/100173 filed on Jun. 15, 2021, which claims the priority of the Chinese patent application with application NO. 202011520126.3 filed at the China National Intellectual Property Administration on Dec. 21, 2020, the entire content of which is incorporated into the present application by reference.

### BACKGROUND

### Technical Field

The present application relates to the technical field of all solid state batteries, in particular, to a composite solid state electrolyte slurry, a thin film, a preparation method and an all solid state battery.

### Description of Related Art

At present, the mainstream in the field of all solid state batteries adopts the method of dry powder mixing to prepare all solid state batteries. However, this process is only suitable for fundamental research and cannot be produced on large scale. Therefore, if it is to be commercialized, it is necessary to develop a new film-forming process that is compatible with the traditional lithium-ion battery preparation process.

However, the existing solid state electrolytes react with most organic solvents, and are difficult to be uniformly dispersed in the slurry, and it is difficult to obtain a slurry suitable for preparing a solid state electrolyte film.

Therefore, the prior art needs to be further improved.

### SUMMARY

The present application provides a composite solid state electrolyte slurry, a preparation method, and an all solid state battery, which aims to solve the technical problem to a certain extent that the solid state electrolyte in the prior art is difficult to be ball-milled, and is difficult to disperse uniformly in the slurry, and it is difficult to obtain a chemically stable slurry for preparing solid state electrolyte film.

The technical solutions of the present application to solve the above technical problems are as follows:

On a first aspect, a preparation method of a composite solid state electrolyte slurry, includes:

adding a polymer into a non-polar solvent and mixing the polymer and the non-polar solvent to obtain a sol; and

adding a solid state electrolyte powder and a lithium salt solution into the sol and mixing the solid state electrolyte powder, the lithium salt solution and the sol to obtain a composite solid state electrolyte slurry.

The non-polar solvent is an organic solvent that does not react with the solid state electrolyte powder.

Optionally, in the preparation method of a composite solid state electrolyte slurry, the polymer is one or more selected from the group consisting of a styrene butadiene rubber, a nitrile rubber, a butyl rubber, a hydrogenated nitrile rubber, a natural rubber, an isoprene rubber, a butadiene rubber, a chloroprene rubber, a silicone rubber, fluorine rubber, a polysulfide rubber, a polyurethane rubber, a chlorohydrin rubber, an acrylic rubber, and an ethylene-propylene rubber.

Optionally, in the preparation method of a composite solid state electrolyte slurry, the non-polar solvent is an organic solvent having a polarity value less than 5. The organic solvent is one or more selected from the group consisting of hexane, toluene, o-xylene, p-xylene, dichloromethane, and dibromomethane.

Optionally, in the preparation method of a composite solid state electrolyte slurry, the lithium salt in the lithium salt solution is one or more selected from the group consisting of lithium bis((trifluoromethyl)sulfonyl)azanide, lithium difluorosulfonimide, aluminum perchlorate, lithium tetrafluoroborate, lithium hexafluorophosphate, lithium trifluoromethanesulfonate, tetraethylammonium tetrafluoroborate, lithium borate bisoxalate, and lithium difluorooxalate.

Optionally, in the preparation method of a composite solid state electrolyte slurry, the solid state electrolyte is one or more selected from the group consisting of an Li rich anti-perovskite (LiRAP), a sulfide solid state electrolyte, a lithium lanthanum zirconium oxide, a lithium titanium aluminum phosphate, and a lithium titanium aluminum phosphate halide.

Optionally, in the preparation method of a composite solid state electrolyte slurry, the inverse perovskite is selected from one or more of Li₃₋ₓMₓOX and Li_{2-y}M_{y}OHX, in which 0≤x≤3; 0≤y≤2; M is selected from one or more of Na, K, Rb, Cs, Be, Ca, Mg, Al, Sr, Ba, Ga, In, Fe, Co, Ni, Y; and La, X is selected from one or more of F, Cl, Br, I, BF₄, BH₄, and NH₂. For example, Li_{2.94}Na_{0.01}Mg_{0.01}Al_{0.01}OCl_{0.7}Br_{0.1}I_{0.1}(BF₄)_{0.1}

Optionally, in the preparation method of a composite solid state electrolyte slurry, the solid state electrolyte is LiRAP, and the LiRAP powder is obtained after pulverizing the LiRAP, which includes:

mixing LiRAP with the non-polar solvent, and grinding the LiRAP containing the non-polar solvent; and

drying the LiRAP containing the non-polar solvent obtained after grinding to obtain LiRAP powder.

Optionally, in the preparation method of a composite solid state electrolyte slurry, the mixing LiRAP with the non-polar solvent, and grinding the LiRAP containing the non-polar solvent includes:

adding the LiRAP, grinding balls and the non-polar solvent into a ball milling tank in an inert atmosphere, and grinding the LiRAP and the non-polar solvent under predetermined grinding conditions. The predetermined grinding conditions include: a grinding time of 0.01-120 hours

Optionally, in the preparation method of a composite solid state electrolyte slurry, the drying the LiRAP containing the non-polar solvent obtained after grinding to obtain LiRAP powder includes:

drying the LiRAP containing the non-polar solvent obtained after grinding under vacuum or heating conditions. The vacuum degree is 0.01-10⁵ Pa and the vacuum retention are 0.01-120 hours.

Optionally, in the preparation method of a composite solid state electrolyte slurry, a heating temperature is 25-200° C. and a heating retention is 0.01-120 hours.

Optionally, in the preparation method of a composite solid state electrolyte slurry, the polymer is mixed with the non-polar solvent to obtain a sol, and a mass ratio of the polymer to the non-polar solvent is 0.001-99.999%.

Optionally, in the step of the preparation method of a composite solid state electrolyte slurry, adding the solid state electrolyte powder and the lithium salt solution into the sol and mixing the solid state electrolyte powder, the lithium salt solution and the sol to obtain a composite solid state electrolyte slurry, a mass ratio of the solid state electrolyte powder to the polymer in the sol is 0.1-99.9%.

On a second aspect, a composite solid state electrolyte slurry is provided, in which the composite solid state electrolyte slurry is prepared by the above preparation method.

On a third aspect, a composite solid state electrolyte film is provided, in which the composite solid state electrolyte film is prepared by using the above composite solid state electrolyte slurry.

On a fourth aspect, an all solid state battery, includes an electrode sheet, in which the above composite solid state electrolyte film is deposited on the electrode sheet.

### BENEFICIAL EFFECTS

The present application provides a preparation method of a composite solid state electrolyte slurry. Sol is formed by mixing polymer and non-polar solvent, solid state electrolyte powder and lithium salt solution are added to the sol, and the composite solid state electrolyte slurry is obtained after mixing the solid state electrolyte powder, the lithium salt solution and the sol; disperses solid state electrolyte powder and lithium salt solution by using of high shear force of the sol, so that the solid state electrolyte powder and lithium salt solution are evenly dispersed in sol. Since the non-polar solvent used does not react with the solid state electrolyte powder, the resulting composite solid state electrolyte slurry has high stability.

### BRIEF DESCRIPTION OF THE DRAWINGS

FIG. 1 shows the dispersion photos of LiRAP in different solvents, where TEGDE: ethylene glycol dimethyl ether, Ethanol: ethanol, NMP: methylpyrrolidone, DBM: dibromomethane, AN: acetonitrile, DMF: dimethylformamide;

FIG. 2 is a photo of LiRAP powders after ball milling. A, without an organic solvent and agglomeration occurs, B, C, ball milling effect after adding solvent, B contains solvent after ball milling, C is dried after ball milling, there is no agglomeration after ball milling, and the small balls of figures are grinding balls;

FIG. 3 is a flow chart of a preparation method of a composite solid state electrolyte slurry provided by an embodiment of the present application;

FIG. 4 is a preparation process flow chart of the LiRAP-based composite solid state electrolyte provided by an embodiment of the present application;

FIG. 5 is an XRD pattern of LiRAP powder and LiRAP/polymer composite solid state electrolyte provided by an embodiment of the present application;

FIG. 6 is an XRD pattern of dry powder after mixing LiRAP in different polar solvents for 24 hours provided by an embodiment of the present application;

FIG. 7 is a photo of the LiRAP/polymer composite solid state electrolyte gel after curing in situ provided by an embodiment of the present application;

FIG. 8 is a temperature-varying lithium ion conductivity curve of different mass fractions of Li₂OHCl_{0.5}Br_{0.5}/nitrile rubber composite solid state electrolyte provided by an embodiment of the present application;

FIG. 9 is a lithium symmetric battery cycle performance test result of an all solid-state battery provided by an embodiment of the present application;

FIG. 10 is a cycle charge-discharge performance curve and coulomb efficiency of a button-type all solid state battery provided by an embodiment of the present application;

FIG. 11 is a voltage-capacity curve of a button-type all solid state battery provided by an embodiment of the present application during cyclic charging and discharging;

FIG. 12 is a cyclic charge-discharge performance curve of a pouch-type all solid state battery provided by an embodiment of the present application;

FIG. 13 is a voltage-time curve of a soft-packed all solid state battery during cyclic charging and discharging provided by an embodiment of the present application.

### DETAILED DESCRIPTION

In order to facilitate the understanding of the present application, the present application will be described more fully below with reference to the relevant drawings. The preferred embodiments of the present application are shown in the drawings. However, the present application can be implemented in many different forms and is not limited to the embodiments described herein. On the contrary, the purpose of providing these embodiments is to make the disclosure of the present application more thorough and comprehensive.

Unless otherwise defined, all technical and scientific terms used herein have the same meaning as commonly understood by those skilled in the technical field of the present application. The terminology used in the specification of the present application herein is only for the purpose of describing specific embodiments, and is not intended to limit the present application.

Because lithium-ion batteries have the advantages of high energy density, large output power, no memory effect, and low self-discharge, they are widely used in the 3C field, new energy vehicles, and energy storage stations. However, due to the use of liquid electrolyte, commercial lithium-ion batteries have shortcomings such as easy leakage, flammability, and poor stability, which are prone to safety accidents and become the main technical obstacles restricting the development of new energy vehicles.

At present, solid state electrolytes (SSE) are mainly divided into two categories: polymer SSE and inorganic SSE. The polymer electrolyte uses organic substances (such as polyethylene oxide (PEO), PVDF-HFP, etc.). Inorganic solid state electrolytes include oxides (such as lithium lanthanum zirconium oxide Li₇La₃Zr₂O₁₂, LLZO, lithium titanium aluminum phosphate Li_{1.4}Al_{0.4}Ti_{1.6}(PO₄)₃) and sulfides (e.g. Li₇P₃S₁₁). Polymer solid state electrolytes are flexible, easy to process, and cost-effective. However, the room temperature lithium ion conductivity of this type of electrolyte is low (10⁻⁶ S cm⁻¹ in the order of magnitude), mechanical strength is poor, and it is not resistant to lithium dendrites, which may easily cause battery short circuit. Inorganic SSE lithium ion has high lithium ion conductivity (up to the order of 10⁻² S cm⁻¹) and good safety. However, the oxide SSE is hard and brittle, not easy to process and shape, and sulfide is prone to produce highly toxic H₂S gas after contact with water which brings safety hazards. By mixing the polymer solid state electrolyte with the inorganic solid state electrolyte, combining the advantages of the two and making up for their shortcomings, a composite solid state electrolyte (CPE) can be prepared. Studies have shown that replacing SiO₂ or Al₂O₃ with inorganic solid state electrolytes as fillers can increase the lithium ion conductivity of CPE by an order of magnitude. At present, lithium ion conductivity of the CPE reported in the literature can reach the order of 10⁻³ S cm⁻¹, which has broad commercialization prospects.

LiRAP SSE has high lithium ion conductivity (up to 10⁻³ S cm⁻¹), wide electrochemical stability window, low preparation temperature, low cost, easy mass production, and broad commercial prospects. At present, after LiRAP sintering, it is impossible to prepare powders with uniform and small particle sizes. This is mainly due to the large amount of LiRAP attached to the inner wall of the ball milling tank and the surface of the grinding ball after ball milling, as shown in FIG. 2, which greatly reduces the effect of ball milling, and the powder loss is large. How to reduce the size of LiRAP particles is one of the technical problems in this field.

At present, the mainstream in the field of all solid state batteries adopts the method of dry powder mixing to prepare all solid state batteries. However, this process is only suitable for fundamental research and cannot be produced on large scale. This kind of battery often has a small active material load and low energy density, which loses the inherent advantages of high energy density of all solid-state batteries; the contacts between particles are poor and internal resistance is large; SSE is prone to decomposition at the interface between SSE and electrode materials; the batteries have no flexibility, unsuitable for real application scenarios, easily broken by vibration; They use large amount of solid state electrolyte, increasing the cost. Therefore, if LiRAP is to be commercialized, it is necessary to develop a new film-forming process that is compatible with the traditional lithium-ion battery preparation process. However, LiRAP reacts with most organic solvents (as shown in FIG. 1), it is difficult to mechanically and finely pulverize because it is easy to agglomerate and adhere in the ball mill tank under the action of mechanical force (as shown in a in FIG. 2), and it is difficult to disperse evenly in the slurry.

Based on these concerns, the present application provides a solution that can solve the above technical problems, the details of which will be described in subsequent embodiments.

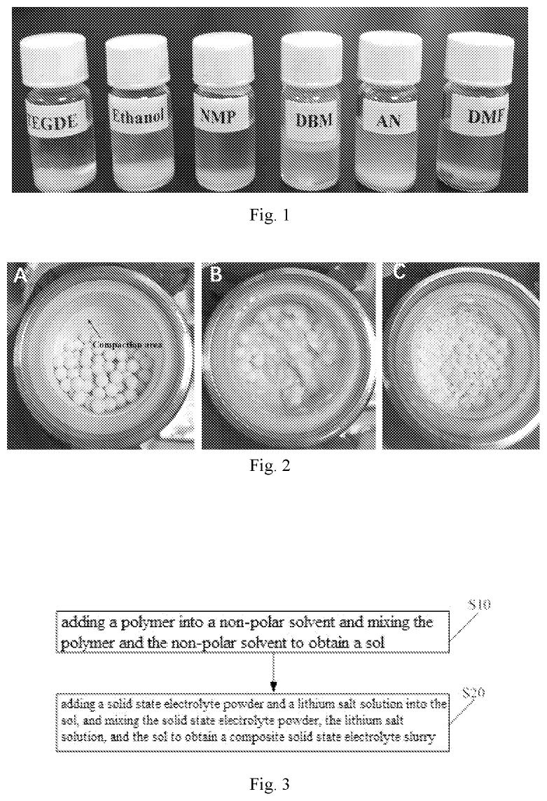

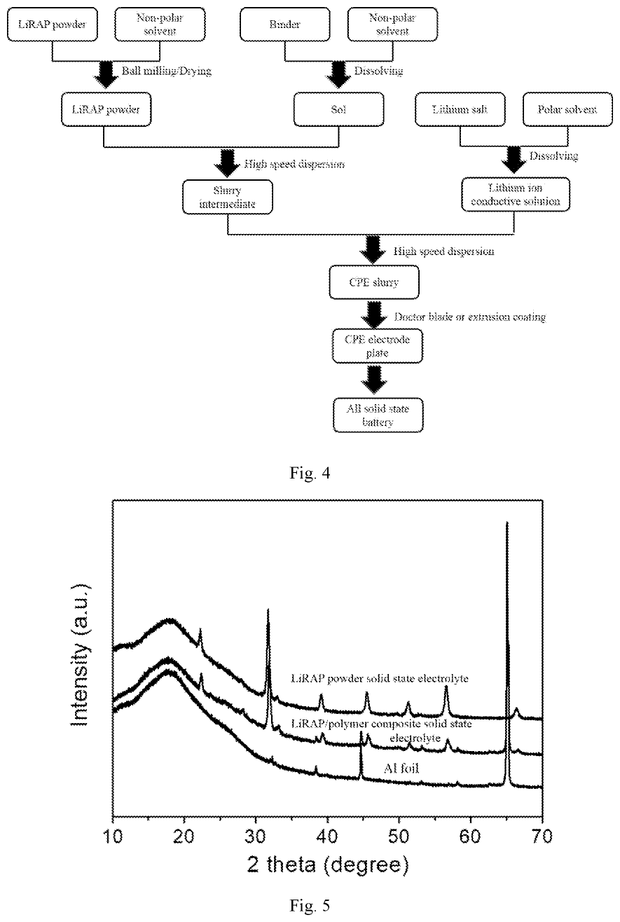

As shown in FIGS. 3 to 4, the embodiment of the present application provides a preparation method of a composite solid state electrolyte slurry, and the method includes the following steps:

S10. adding a polymer into a non-polar solvent and mixing the polymer and the non-polar solvent to obtain a sol.

The polymer is a type of organic substances that is dissolved in an organic solvent and has cohesiveness. The polymer can be natural rubber or synthetic rubber, including but not limited to styrene butadiene rubber, nitrile rubber, and butyl rubber, hydrogenated butadiene rubber, natural rubber, isoprene rubber, butadiene rubber, neoprene rubber, silicone rubber, fluorine rubber, polysulfide rubber, polyurethane rubber, epichlorohydrin rubber, acrylic rubber, ethylene propylene rubber. It should be noted that the polymer may be a single natural rubber or synthetic rubber, or a mixture of natural rubber and synthetic rubber. When it is a mixture, the mixing ratio of natural rubber and synthetic rubber is not limited.

In the present embodiment, the non-polar solvent may be all organic solvent with a polarity less than 5, including but not limited to, hexane, toluene, o-xylene, p-xylene, methylene chloride, and dibromomethane. It should be noted that the non-polar solvent can be a single organic solvent with a polarity less than 5, or a mixture of multiple organic solvents with a polarity less than 5, for example, it can be a single toluene, o-xylene, hexane, etc., it may also be a mixture of toluene and o-xylene, or a mixture of toluene, o-xylene, p-xylene, methylene chloride, and dibromomethane. The specific mixing ratio and the type of mixing are not limited here.

In the present embodiment, as an example, dichloromethane can be used as the solvent, styrene-butadiene rubber as the polymer, a certain amount of styrene-butadiene rubber and a certain amount of dichloromethane were added to a container under stirring and heating conditions and they were dissolved at a certain stirring speed to form into a sol (heating can speed up the dissolution rate of styrene butadiene rubber). Among them, the mass ratio of styrene butadiene rubber to dichloromethane can be 0.001% to 1.0%, 1.0% to 10.0%, 10.0% to 20.0%, 20.0% to 40.0%, 40.0% to 60.0%, 60.0% to 80.0%, 80.0% to 90.0%, 90.0% to 99.999%. The heating temperature may be 25° C. to 50° C., 50° C. to 80° C., 80° C. to 120° C., 120° C. to 140° C., 140° C. to 160° C., 160° C. to 180° C., 180° C. to 200° C. It should be noted that the model of the stirrer and the speed of the stirrer can be adjusted according to actual needs.

S20. adding a solid state electrolyte powder and a lithium salt solution into the sol and mixing the solid state electrolyte powder, the lithium salt solution and the sol to obtain a composite solid state electrolyte slurry; the non-polar solvent is an organic solvent that does not react with the solid state electrolyte powder.

The solid state electrolyte powder was added into the sol under stirring conditions to disperse the solid state electrolyte powder to obtain a dispersion liquid containing the solid state electrolyte powder. Then, a certain concentration of lithium salt solution was added into the dispersion liquid, and dispersed to obtain a composite solid state electrolyte slurry.

In the present embodiment, the solid state electrolyte powder can also be added together with a certain concentration of lithium salt solution, and then dispersed to obtain a composite solid state electrolyte slurry. It should be noted that the shear force of the slurry on the particles during the high-speed movement is directly proportional to the viscosity of the liquid. Because the polymer is dissolved in an organic solvent to form a viscous sol. The higher the mass ratio of polymer, the greater the viscosity of sol, and the greater the shear force during stirring.

In the present embodiment, by using the high shear force of sol, the combined solid state electrolyte powder and lithium salt solution can be better dispersed in sol.

In the present embodiment, a non-polar organic liquid is used as a solvent for LiRAP ball milling and the preparation of a rubber-based polymer electrolyte matrix, so that the material does not stick to the wall and remains stable during LiRAP ball milling, and a slurry with uniform particle size and uniform dispersion can be prepared. Using rubber as the matrix of polymer electrolyte, it has good chemical compatibility with non-polar solvent and LiRAP.

At the same time, the in-situ polymerization technology is used to cause the polymer to undergo in-situ polymerization at a temperature below 100° C. to further improve the cycle performance of the lithium symmetric battery of CPE material. An appropriate amount of LiPF₆ electrolyte was added to CPE, and the LiPF₆ will be used to decompose at 60-80° C. to release PF₅ gas. PF₅ will act as an initiator to carry out in-situ polymerization of polymer with unsaturated chemical bonds. The molecular structure of styrene-butadiene rubber before in-situ polymerization is shown below:

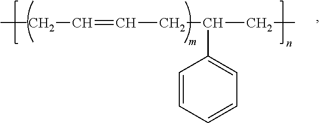

and the molecular structure of nitrile rubber before in-situ polymerization:

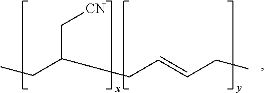

they both contain unsaturated carbon-carbon double bonds. It is easy to understand that m, n, x, and y in the molecular structural formula are all positive integers.

In one implementation of the present embodiment, the solid state electrolyte powder is obtained by pulverizing the solid state electrolyte. The solid state electrolyte includes, but not limited to, LiRAP, sodium-rich antiperovskite, potassium-rich antiperovskite, sulfide solid state electrolyte, lithium lanthanum zirconium oxide, lithium titanium aluminum phosphate, lithium titanium aluminum phosphate halide, and the present application is particularly applicable for solid state electrolyte that easily reacts with conventional organic solvents. In which, the pulverization can be pulverized by using a mortar, a mechanical pulverizer, a universal pulverizer, a solid pulverizer, a milling pulverizer, and the like. It should be noted that in order to make the obtained slurry have better electrochemical performance, it is necessary to reduce the size of the electrolyte powder to a certain particle size.

In the present embodiment, when the solid state electrolyte is an anti-perovskite, which includes but not limited to, one or more of Li₃₋ₓMₓOX and Li_{2-y}M_{y}OHX, where 0 [symbol] x [symbol] 3, 0 [symbol] y [symbol] 2, M is selected from one or more selected from the group consisting of Na, K, Rb, Cs, Be, Ca, Mg, Al, Sr, Ba, Ga, In, Fe, Co, Ni, Y, La, X is one or more selected from the group consisting of F, Cl, Br, I, BF₄, BH₄, NH₂. For example, Li₂OHCl_{0.5}Br_{0.5}, Li_{1.5}Na_{0.5}OHCl_{0.3}Br_{0.7} and Li_{2.75}La_{0.05}Mg_{0.05}OCl_{0.95}(BF₄)_{0.05}, etc.

In one implementation of the present embodiment, the solid state electrolyte is LiRAP, and the specific steps of pulverizing LiRAP to prepare LiRAP powder may include:

S1 mixing the LiRAP with the non-polar solvent, and grinding the LIRAP containing the non-polar solvent.

Under the protection of inert gas such as Ar or N₂, the LiRAP prepared by the solid-phase reaction is pulverized using a pre-pulverizing device, so that the particle size reaches the millimeter level. Under the protection of inert gas such as Ar or N₂, the pre-pulverized LiRAP powder, grinding balls and non-polar solvent were put into the ball milling tank in a certain ratio, adjusting the speed of the ball milling, and grinding the LiRAP. The grinding result is shown in b and c of FIG. 2, it can be seen from the figure that after adding the solvent, there is no agglomeration in the grinding, and the ball milling is very uniform.

In the present embodiment, the milling ball is a zirconia milling ball or a stainless steel milling ball, and its diameter is in the range of 100 mm-0.01 mm. The rotating speed of the ball milling is 1-9999 rpm, and the ball milling time is 0.01-120 h.

In the present embodiment, the addition of a certain amount of non-polar solvent as a wetting agent during the ball milling process can effectively prevent the adhesion of LiRAP powder on the inner wall of the ball milling tank. In addition, the heat generated in the ball milling process evaporates the organic solvent to provide a protective atmosphere.

S2 drying the LiRAP containing the non-polar solvent obtained after grinding to obtain LiRAP powder.

The LiRAP containing the non-polar solvent obtained after grinding is dried under vacuum or heating conditions; the vacuum condition is maintained at 0.01-10⁵ Pa for 0.01-120 hours. The heating condition is heating at 25-600° C. for 0.01-120 hours.

In the present embodiment, after the ball milling is completed, the ball milling tank was opened in an inert gas atmosphere glove box, and the organic solvent was volatilized in a vacuum environment or under heating conditions.

In an implementation of the present embodiment, the lithium salt solution, in which the lithium salt includes: lithium bis(trifluoromethylsulfonyl)imide, lithium bisfluorosulfonimide, aluminum perchlorate, lithium tetrafluoroborate, lithium hexafluorophosphate, lithium trifluoromethanesulfonate, tetraethyl ammonium tetrafluoroborate, lithium bisoxalate borate, lithium difluorooxalate borate. In the lithium salt solution, the solvent is a lipid or ether solvent, including but not limited to, one or mixture selected from the group consisting of ethylene carbonate (EC), dimethyl carbonate (DMC), diethyl carbonate (DEC), ethylene glycol dimethyl ether (DME), 1,3 dioxolane (DOL), propylene carbonate (PC), ethyl methyl carbonate (EMC), fluoroethylene carbonate (FEC), propyl acetate (PA), Triethylene glycol dimethyl ether (TRIGLYME), vinylene carbonate (VC), 1,3-propane sultone (PS), vinyl ethylene carbonate (VEC), etc. Or a mixed solvent obtained by mixing one or more of the above solvents with an organic solvent with a polarity value greater than 4.5.

In the present embodiment, the concentration of the lithium salt solution may be 0.001-10 mol/L (for example, 1 mol/L).

In an implementation of the present embodiment, after the composite solid state electrolyte slurry is prepared, the slurry can be coated on the substrate, and dried to obtain a composite solid state electrolyte film.

A coating device was used to coat the selected substrate at a certain speed to obtain a composite solid state electrolyte wet film with a certain thickness, and then the composite solid state electrolyte wet film was dried under a certain temperature condition to obtain a composite solid state electrolyte film.

In the present embodiment, the coating device includes, but not limited to, an extrusion coater, a knife coater, and a cast coater; the substrate includes Al foil, Cu foil, stainless steel foil, PI film, polytetrafluoroethylene film, commercial lithium-ion battery separator, lithium-ion battery positive electrode sheet, negative electrode sheet.

In the present embodiment, the coating speed of the coating device can be 0.01 m/min to 10 m/min, 10 m/min to 50 m/min, 50 m/min to 100 m/min, and 100 m/min to 100 m/min. 150 m/min, 150 m/min to 200 m/min. The wet film thickness may be 1 to 50 microns, 50 to 100 microns, 100 to 200 microns, 200 to 400 microns, 400 to 600 microns, 600 to 800 microns, 800 to 1000 microns. The temperature may be 30° C. to 50° C., 50° C. to 70° C., 70° C. to 100° C., 100° C. to 130° C., 130° C. to 150° C., 150° C. to 180° C., 180° C. to 200° C.

Based on the same inventive concept, the present application also provides an all solid state battery, which includes an electrode sheet on which a solid state electrolyte film is deposited.

The positive electrode sheet can be used as the substrate, and a knife coater was used to coat the positive electrode sheet with the composite solid state electrolyte slurry, and the solid state electrolyte film is obtained after drying. Then put the negative electrode sheet in contact with the positive electrode sheet to assemble an all solid state battery.

The composite solid state electrolyte slurry provided by the present application and the preparation method thereof will be further explained by specific preparation embodiments below.

### Example 1

10 ml of dichloromethane and 5 g of LiRAP were mixed and then added to a ball milling tank, and were milled for 24 hours at a rotation speed of 500 rpm, in which during which, a zirconia grinding ball having a diameter of 5 mm was selected. After the ball milling was finished, in an inert gas atmosphere glove box, the ball mill tank was opened, and the solvent was volatilized under vacuum conditions to obtain LiRAP powder for use, where LiRAP is Li₂OHCl_{0.5}Br_{0.5}.

In a glove box in a nitrogen environment, taking 30 ml of dichloromethane as a solvent, and 5 g of a nitrile rubber was added into the dichloromethane to completely disperse the nitrile rubber in dichloromethane to obtain a sol.

The obtained LiRAP powder was added to the sol under stirring and uniformly dispersed, and then 3 ml of lithium tetrafluoroborate solution with a concentration of 0.5 mol/L and 0.5 ml of lithium hexafluorophosphate solution with a concentration of 1 mol/L were added to the dispersion liquid, continuing to stir at high speed to make the mixture evenly mixed to obtain a CPE slurry based on LiRAP. The photo of the CPE slurry after curing in situ is shown in FIG. 7.

In a nitrogen atmosphere, the nitrile rubber-based CPE slurry was coated on the Cu foil by the extrusion coating method, dried at a temperature of 50° C., and then cured at a temperature of 70° C., to obtain a composite solid state electrolyte based on LiRAP CPE.

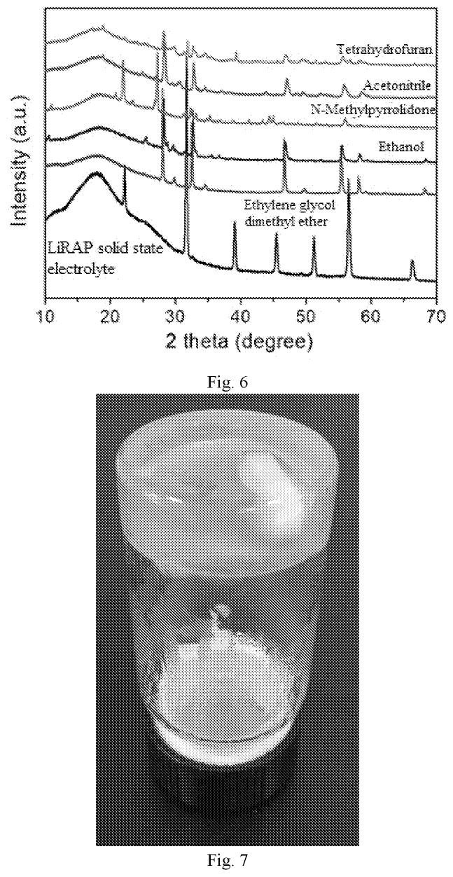

After the LiRAP-based CPE prepared in the above-mentioned embodiment was in contact with the solvent, XRD was tested, and the results are shown in FIGS. 5 to 6, and the XRD shows no phase change.

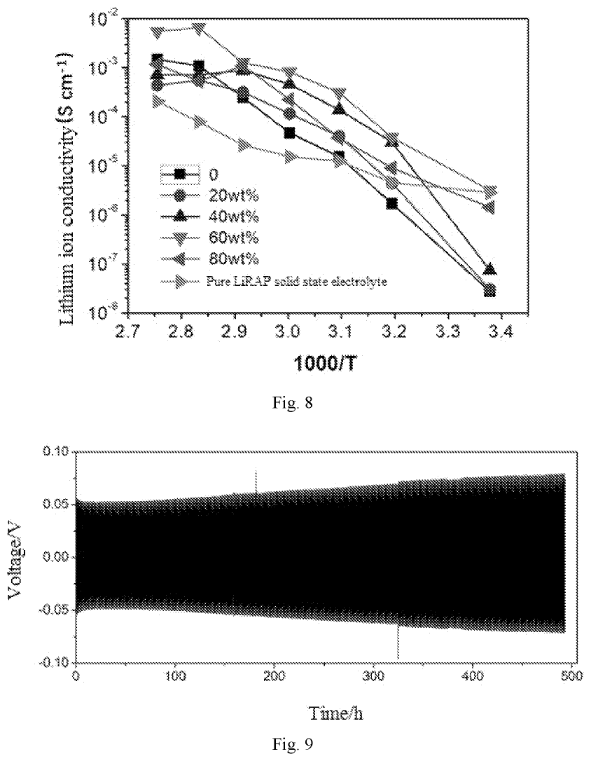

The ionic conductivity of different mass ratios of Li₂OHCl_{0.5}Br_{0.5}/nitrile rubber CPE was tested. As shown in FIG. 8, the ionic conductivity of the composite solid state electrolyte was higher than that of the LiRAP solid state electrolyte.

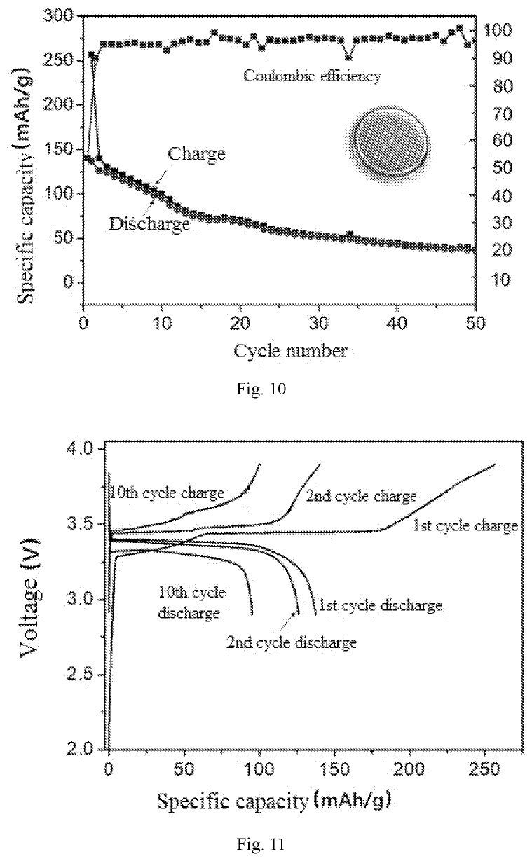

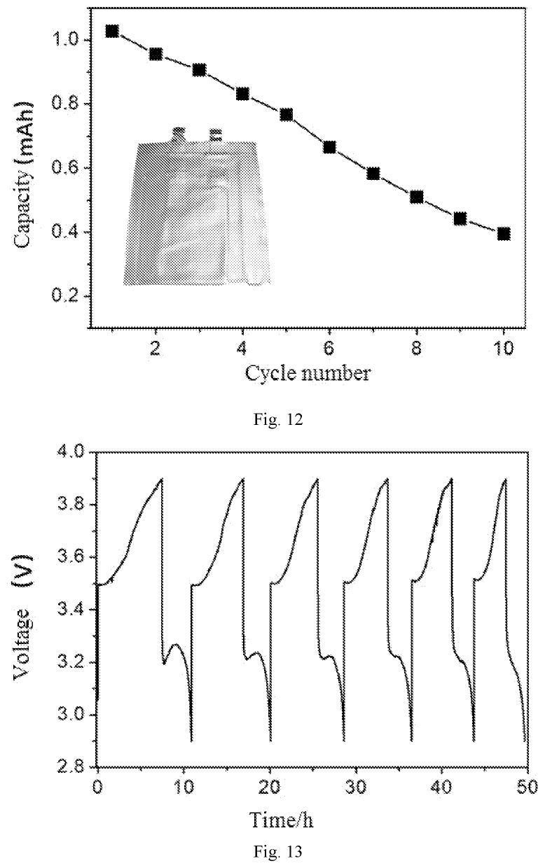

The LiRAP-based CPE was prepared using the preparation method provided in Example 1, and then assembled into an all solid state battery. The battery was subjected to performance testing. Among them, the lithium symmetric battery had a cycle performance of 490 times, as shown in FIG. 9. The button-type all solid state battery assembled with LiFePO₄ as the positive electrode and lithium metal as the negative electrode has a discharge capacity of 36% of the initial capacity after 50 cycles, as shown in FIG. 10. During the first 10 cycles, the LiFePO₄ charge and discharge platform was relatively stable, as shown in FIG. 11. The pouch-type all solid-state battery assembled with LiFePO₄ as the positive electrode and lithium metal as the negative electrode has a discharge capacity of 38% of the initial capacity after 10 cycles, as shown in FIG. 12. During the first 6 cycles, the LiFePO₄ charge and discharge platform was relatively stable, as shown in FIG. 13.

In conclusion, the present application provides a composite solid state electrolyte slurry, a preparation method and a solid lithium battery. The method includes: adding polymer to a non-polar solvent and mixing the polymer and the non-polar solvent to obtain a sol; adding solid state electrolyte powder and lithium salt solution to the sol to obtain a composite solid state electrolyte slurry; the non-polar solvent was an organic solvent which does not react with the solid state electrolyte powder. The sol was formed by mixing the polymer and the non-polar solvent. Solid state electrolyte powder and lithium salt were added to the sol to obtain composite solid state electrolyte slurry. The high shear force of sol is used to disperse the solid state electrolyte powder and lithium salt solution, thereby the solid state electrolyte powder and the lithium salt solution are uniformly dispersed in the sol. Since the non-polar solvent used does not react with the solid state electrolyte powder, the resulting composite solid state electrolyte slurry has high stability. The prepared composite solid state electrolyte slurry was coated onto a film to obtain a composite solid state electrolyte CPE, which was applied to an all-solid battery to improve the cycle performance of the battery.

The above are only the preferred embodiments of the present application and are not intended to limit the present application. Any modification, equivalent replacement, improvement, etc. made within the spirit and principle of the present application shall be within the protection of the present application.

1. A preparation method of a composite solid state electrolyte slurry, wherein comprising:
adding a polymer into a non-polar solvent and mixing the polymer and the non-polar solvent to obtain a sol; and
adding a solid state electrolyte powder and a lithium salt solution into the sol, and mixing the solid state electrolyte powder, the lithium salt solution, and the sol to obtain a composite solid state electrolyte slurry;
wherein
the non-polar solvent is an organic solvent that does not react with the solid state electrolyte powder.

2. The preparation method of a composite solid state electrolyte slurry according to claim 1, wherein the polymer is one or more selected from the group consisting of a styrene butadiene rubber, a nitrile rubber, a butyl rubber, a hydrogenated nitrile rubber, a natural rubber, an isoprene rubber, a butadiene rubber, a chloroprene rubber, a silicone rubber, a fluorine rubber, a polysulfide rubber, a polyurethane rubber, a chlorohydrin rubber, an acrylic rubber, and an ethylene-propylene rubber.

3. The preparation method of a composite solid state electrolyte slurry according to claim 1, wherein the non-polar solvent is an organic solvent having a polarity value less than 5; and the organic solvent is one or more selected from the group consisting of hexane, toluene, o-xylene, p-xylene, dichloromethane, and dibromomethane.

4. The preparation method of a composite solid state electrolyte slurry according to claim 1, wherein the polymer and the non-polar solvent are mixed under heating and stirring conditions, and the mass ratio of the polymer and the non-polar solvent is 0.001-99.999%, and the heating temperature is 25° C.-200° C.

5. The preparation method of a composite solid state electrolyte slurry according to claim 1, wherein the solid state electrolyte powder is obtained by pulverizing the solid state electrolyte, and the solid state electrolyte is one or more selected from the group consisting of an Li-rich anti-perovskite, a sulfide solid state electrolyte, a lithium lanthanum zirconium oxide, a lithium titanium aluminum phosphate, and a lithium titanium aluminum phosphate halide.

6. The preparation method of a composite solid state electrolyte slurry according to claim 5, wherein the Li-rich anti-perovskite is selected from one or more of Li3-xMxOX and Li2-yMyOHX,
wherein
0≤x≤3,
0≤y≤2,
M is selected from one or more of Na, K, Rb, Cs, Be, Ca, Mg, Al, Sr, Ba, Ga, In, Fe, Co, Ni, Y, and La, and
X is selected from one or more of F, Cl, Br, I, BF4, BH4, and NH2.

7. The preparation method of a composite solid state electrolyte slurry according to claim 5, wherein the solid state electrolyte is an anti-perovskite, and the anti-perovskite powder is obtained after pulverizing the anti-perovskite, which specifically comprises:
adding the anti-perovskite, grinding balls and the non-polar solvent into a ball milling tank in an inert atmosphere, and grinding the anti-perovskite and the non-polar solvent under predetermined grinding conditions; and
drying the anti-perovskite containing the non-polar solvent obtained after grinding under vacuum or heating conditions.

8. The preparation method of a composite solid state electrolyte slurry according to claim 7, wherein the predetermined grinding conditions comprise: a ball mill rotating speed of 1-9999 rpm, and the grinding time of 0.01-120 hours.

9. The preparation method of a composite solid state electrolyte slurry according to claim 7, wherein the heating condition comprises a heating temperature of 25-600° C. and a heating retention of 0.01-120 hours; and the vacuum condition comprises a vacuum degree of 0.01-105 Pa and a vacuum retention of 0.01-120 hours.

10. The preparation method of a composite solid state electrolyte slurry according to claim 1, wherein the lithium salt in the lithium salt solution is one or more selected from the group consisting of lithium bis((trifluoromethyl)sulfonyl)azanide, lithium difluorosulfonimide, aluminum perchlorate, lithium tetrafluoroborate, lithium hexafluorophosphate, lithium trifluoromethanesulfonate, tetraethylammonium tetrafluoroborate, lithium borate bisoxalate, and lithium difluorooxalate.

11. The preparation method of a composite solid state electrolyte slurry according to claim 1, wherein in the step of adding the solid state electrolyte powder and the lithium salt solution into the sol, and mixing the solid state electrolyte powder, the lithium salt solution and the sol to obtain a composite solid state electrolyte slurry, wherein the mass ratio of the solid state electrolyte powder to the polymer in the sol is 1-99%.

12. (canceled)

13. A composite solid state electrolyte film, wherein the composite solid state electrolyte film is prepared by using the composite solid state electrolyte slurry prepared by the preparation method according to claim 1.

14. An all solid state battery, comprising an electrode plate, wherein the composite solid state electrolyte film of claim 13 is deposited on the electrode plate; and the composite solid state electrolyte film has a thickness of 10 nm-1000 μm.
